(19) United States
(12) Patent Application Publication
(10) Pub. No.: US 2015/0105997 A1
(43) Pub. Date: Apr. 16, 2015

(54) METHOD AND DEVICE FOR MONITORING A DRIVE OF A MOTOR VEHICLE

(71) Applicants: Dirk WAGNER, Pfinztal (DE); Magnus OPPELLAND, Stuttgart (DE); Matthias SCHUELER, Steinheim (DE); Volker GILGENBACH, Ludwigsburg (DE)

(72) Inventors: Dirk WAGNER, Pfinztal (DE); Magnus OPPELLAND, Stuttgart (DE); Matthias SCHUELER, Steinheim (DE); Volker GILGENBACH, Ludwigsburg (DE)

(73) Assignee: ROBERT BOSCH GMBH, Stuttgart (DE)

(21) Appl. No.: 14/511,747

(22) Filed: Oct. 10, 2014

(30) Foreign Application Priority Data
Oct. 10, 2013 (DE) 10 2013 220 414.0

(51) Int. Cl. F02D 7/00; B60W 10/06; B60W 10/18; G01P 3/00

(52) U.S. Cl. CPC F02D 7/00; G01P 3/00; B60W 10/06; B60W 10/18
USPC 701/103; 701/102

(57) ABSTRACT

A method for the safe operation of a drive of a motor vehicle, including rotational speed monitoring in which, if an actual rotational speed (n) of an internal combustion engine exceeds a predefinable lower rotational speed threshold (n_max_lower), a fault response action is carried out, the fault response action being selected as a function of whether additional predefinable conditions are present.

### FIELD OF THE INVENTION

The present invention relates to a method for monitoring a drive of a motor vehicle. In other aspects, the present invention relates to a computer program for carrying out this method, an electronic storage medium, and a control unit.

### BACKGROUND INFORMATION

A method for controlling the drive power of a vehicle is known from German Published Patent Appln. No. 44 38 714, in which only one microcomputer is provided for carrying out control functions and monitoring functions. In the microcomputer, at least two levels are established which are independent of each other, a first level carrying out the control functions and a second level carrying out the monitoring functions.

From German Patent No. 10 2013 218 554, which was not pre-published, a method is known for monitoring a drive of a motor vehicle which includes acceleration monitoring, the allowability of the operating state being monitored using rotational speed monitoring instead of acceleration monitoring, if the operating state of the drive meets at least one predetermined condition.

### SUMMARY

The present invention relates to a particularly simple method for the safe operation of a drive of a motor vehicle, the drive including an internal combustion engine and optionally including another drive unit, for example, an electric machine or a hydraulic motor, which may be operable both as a motor and as a generator.

The method according to the present invention further refines the rotational speed monitoring known from German Patent No. 10 2013 218 554. It has the advantage that, if a fault is actually present in the drive, for example, via inadvertent injections and/or an inadvertently elevated torque output, it allows implementation of preferably safe emergency operation which is still controllable by the driver, with which, for example, it is still possible to drive to the nearest repair shop. On the other hand, if no fault is present in the drive, the operation of the drive is made possible with minimal drivability limitations for the driver, without the drivability limitations resulting from the emergency operation.

This particularly simple method is based on rotational speed monitoring. Here, if an actual rotational speed of an internal combustion engine exceeds a predefinable lower rotational speed threshold, a fault response action is then carried out, the fault response action being selected as a function of whether additional conditions are met. These additional conditions may in particular include the condition of whether the actual rotational speed also exceeds a predefinable upper rotational speed threshold. The fault response action is in particular an action which relates to the control of the internal combustion engine.

According to one possible refinement, if the actual rotational speed exceeds the predefinable upper rotational speed threshold, it is checked whether a request for injecting fuel is transmitted to an injector control of a control unit. This request may be carried out within the scope of the control method known from German Published Patent Application No. 44 38 714, for example, by the control function of the first level. If this request is transmitted, it is advantageously provided to transmit a command to the injector control that causes no control command for injecting fuel to be transmitted to the injector, despite the request which has been transmitted to the injector control; i.e., the command “overrules” the request. This command may be carried out, for example, by the monitoring function of the second level within the scope of the control method known from German Published Patent Application No. 44 38 714. It may be provided that the upper rotational speed threshold and/or the lower rotational speed threshold are/is predefined as a function of a driver input which corresponds to a degree of actuation of an accelerator pedal. Thus, the method is particularly convenient for the driver.

In another aspect of the present invention, it may be provided that, if this command results in the injector control not transmitting a control command to the injector for injecting fuel, i.e., if the command has overruled the request as expected, and if the actual rotational speed of the internal combustion engine carries out critical oscillations, at least one action of a plurality of actions for reducing the torque generated by the internal combustion engine via the combustion processes is initiated. In this way, the safety of the operation of the drive train may be improved in a particularly simple manner.

It has been found that within the scope of the method, a situation may occur in which the actual rotational speed of the internal combustion engine drops due to torque-reducing actions as soon as the rotational speed threshold has been exceeded, whereby the rotational speed again drops below the rotational speed threshold. After the rotational speed has dropped below the rotational speed threshold, it may happen that the injection of the internal combustion engine is again enabled and/or the torque-reducing actions are deactivated, whereupon the actual rotational speed increases again, which may cause the described oscillations.

The criteria advantageously include whether critical oscillations are present, the criterion that the actual rotational speed oscillates about the upper rotational speed threshold, and/or the criterion that a maximum value of a time gradient of the actual rotational speed exceeds a predefinable threshold value during a period of the oscillation. The latter may mean that only positive gradients of the rotational speed are considered, whereby it is possible to respond particularly reliably to rapid increases in the rotational speed, thus suppressing potentially dangerous operating states in a particularly effective manner. However, the latter may also mean that the absolute value of the gradient exceeds the predefinable threshold value; thus, a reliable response is also made to a particularly rapid drop in the actual rotational speed.

In one particularly advantageous aspect of the present invention, the plurality of actions includes the initiation of an emergency air mode. In other words, a throttle valve of the internal combustion engine is controlled in such a way that its degree of opening is reduced, thus reducing the torque of the internal combustion engine in a particularly effective manner via the reduction of the quantity of air fed to the combustion. This may, for example, take place via a control of the throttle valve using the “currentless” control command, i.e., a solenoid of the control of the throttle valve is not supplied with current, thus causing the throttle valve to close.

In another particularly advantageous aspect of the present invention, the plurality of actions includes reducing the predefinable rotational speed threshold. This action has the advantage that it is particularly simple and acts particularly rapidly, since the injection path of the internal combustion engine responds particularly rapidly.

According to another aspect of the present invention, it may be provided that, if the control command for injecting fuel is transmitted despite the command to the injector, i.e., if the “overruling” of the request by the command does not lead to the expected result, a reset of control software of the control unit is carried out. It has been found that the unsuccessful “overruling” of the request by the command may be remedied in many cases via a reinitialization of the control software which is triggered by the reset.

According to another aspect of the present invention, it may be provided that, if fuel is still being injected after a predefinable time interval has elapsed, despite the transmission of the command, and if no monitoring-relevant fault is present in another drive unit, in particular in an electric machine or a hydraulic motor of the drive, a deactivation of the injection system of the internal combustion engine is carried out. This means in particular that a reset of the part of the injector control which generates the control command is carried out. No reset of communication interfaces of the control unit is carried out, is available. The word “monitoring-relevant” is, for example, to be understood to mean that it excludes faults as not being monitoring-relevant if the additional drive unit is already safely deactivated or is limited to generator torques. This has the particular advantage that the drive remains controllable via the additional drive unit.

According to another aspect of the present invention, it may be provided that, if fuel is still being injected after a second predefinable time interval has elapsed, despite the transmission of the command, a deactivation of the injection system of the internal combustion engine and a deactivation of communication interfaces of the control device are carried out. These actions may advantageously be triggered within the scope of the control method known from German Published Patent Application No. 44 38 714 via a so-called watchdog deactivation of a third level for hardware monitoring. This action has the particular advantage that it further increases the safety of the drive since, by deactivating the communication interfaces of the control unit, other components of the drive which are connected to these communication interfaces are able to respond to the failure of communication messages of the control unit using a safe emergency operation.

In another aspect of the present invention, if the actual rotational speed does not exceed the predefinable upper rotational speed threshold, a setpoint rotational speed is predefined which is a setpoint value specification for a control of the actual rotational speed. In particular, this predefined setpoint rotational speed is limited in its dynamics, i.e., it is selected in such a way that its time gradient does not exceed a predefinable setpoint rotational speed gradient threshold value. This has the advantage that although an increased driver input is possibly implemented with a slight delay, its implementation is nonetheless possible.

According to another aspect, another fault response action is initiated as a function of whether a time gradient of the actual rotational speed exceeds a second gradient threshold value. The second gradient threshold value may be selected, for example, to be equal to the setpoint rotational speed gradient threshold value, or somewhat greater. In this way, it is possible in a particularly simple manner to check whether the implementation of the setpoint rotational speed is faulty.

According to one possible refinement of this aspect, if the time gradient of the actual rotational speed exceeds the second gradient threshold value, at least one action of a plurality of actions is initiated for reducing the torque generated by the internal combustion engine; for example, a switch to an emergency mode is carried out. In this way, it is possible to respond effectively to the known faulty implementation of the setpoint rotational speed in a particularly simple manner.

In another aspect of the present invention, the additional drive unit of the drive is controlled as a function of whether an intervention of a braking system is present, i.e., the additional predefinable conditions include the condition of whether the intervention of the braking system is present. The term “intervention” is to be understood to be so broadly worded that it also includes cases in which a braking request by a driver of the motor vehicle has been ascertained, but an application of a negative (braking) torque to wheels of the motor vehicle by the brake has not (yet) taken place. A braking request by a driver assistance system, for example, an ACC system, may also be considered to be a braking request by the driver.

Advantageously, if the intervention of the braking system is present, the additional drive unit is operated only as a generator, i.e., the additional drive unit, which, according to this aspect of the present invention, may be operated as a motor, is controlled in such a way that it couples no accelerating torques into the drive.

Here, it may be additionally provided that a generator setpoint torque is predefined for the additional drive unit. In particular, a deceleration of the motor vehicle may thus be initiated particularly rapidly, since the buildup of braking force in a hydraulic braking system is typically delayed by the required buildup of braking pressure.

However, it may alternatively or additionally be provided that, if no intervention is present, the additional drive unit is operated only as a generator. In this way, it may effectively be prevented that the electric machine is able to act in a destabilizing manner during a rotational speed-controlling intervention into the control of the internal combustion engine, thus further increasing the safety of the method.

In another aspect, the present invention relates to a computer program which is designed to carry out all steps of one of the described methods.

In another aspect, the present invention relates to an electronic storage medium on which this computer program is stored.

In another aspect, the present invention relates to a control unit which has such an electronic storage medium.

### BRIEF DESCRIPTION OF THE DRAWINGS

FIG. 1 schematically depicts the structure of a monitoring method of the drive train.

FIG. 2 depicts a possible selection of the rotational speed thresholds.

FIG. 3 schematically depicts the structure of the rotational speed monitoring.

### DETAILED DESCRIPTION

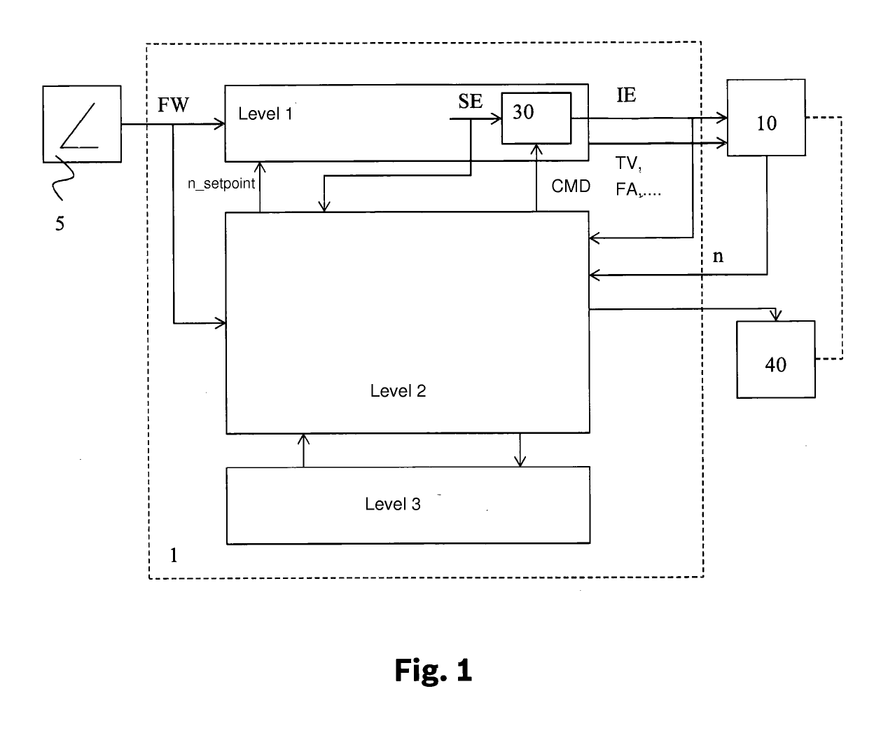

FIG. 1 depicts control unit 1, in which the method according to the present invention may run. In the depicted non-limiting exemplary embodiment, control unit 1 includes a microprocessor on which the method according to the present invention runs. Control unit 1 receives a degree of actuation FW in a known manner from an accelerator pedal sensor 5 which, for example, is normalized from 0 (accelerator pedal not actuated) to 1 (accelerator pedal fully actuated). The control unit controls internal combustion engine 10 and electric machine 40.

The first level, level 1, ascertains suitable control variables for internal combustion engine 10 from degree of actuation FW, in particular, degree of opening of throttle valve TV and firing angle FA, which are transmitted to internal combustion engine 10. The first level includes injector control 30. In the first level, request SE for injecting fuel is transmitted to injector control 30. From this, injector control 30 ascertains control command IE, which is transmitted to the injectors of internal combustion engine 10 and thus controls the opening and closing of the injectors.

The second level, level 2, ascertains a setpoint rotational speed n_setpoint from degree of actuation FW, which the second level transmits to the first level. A rotational speed controller in level 1 attempts to carry out the control of internal combustion engine 10 in such a way that actual rotational speed n of internal combustion engine 10 corresponds to setpoint rotational speed n_setpoint. The second level may furthermore intervene directly into injector control 30 of the first level via command CMD, and may prevent injector control 30 from transmitting control command IE to the injectors of internal combustion engine 40 via command CMD.

The third level, level 3, includes the hardware monitoring, and in addition to monitoring for hardware faults such as flipped bits, includes a watchdog which checks the functioning of control unit 1 in a known manner with the aid of continuous query-response communication between the microprocessor and a separate monitoring component. The third level is thus able to reliably monitor the correct operation of the second level. In the event of a fault, for example, in the event of impermissible injections, the second level may intentionally interrupt the monitoring by the third level, so that the watchdog monitoring responds, and the separate monitoring component prevents additional injections and possibly the communication with other control units (in particular in terms of hardware).

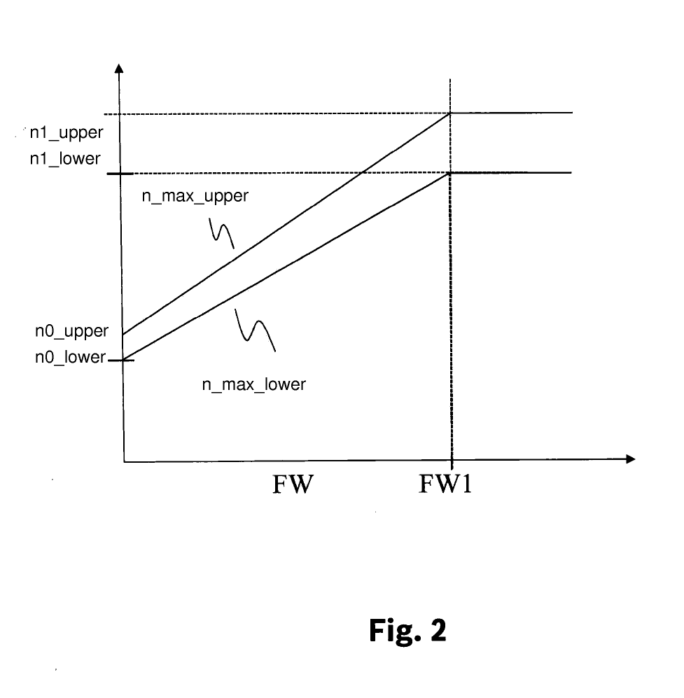

In the exemplary embodiment, the rotational speed monitoring is carried out as part of the second level and also receives degree of actuation FW. As depicted in FIG. 2 by way of example, the rotational speed monitoring ascertains lower rotational speed threshold n_max_lower and upper rotational speed threshold n_max_upper based on the degree of actuation FW, for example, via a characteristic curve in each case. It is possible that lower rotational speed threshold n_max_lower and/or upper rotational speed threshold n_max_upper is/are configured independently of degree of actuation FW. However, in this exemplary embodiment, lower rotational speed threshold n_max_lower and upper rotational speed threshold n_max_upper are selected as a function of degree of actuation FW. If degree of actuation FW equals 0, the accelerator pedal is thus not actuated, and lower rotational speed threshold n_max_lower assumes a lower initial value n0_lower which is preferably greater than the no-load rotational speed of the engine, for example, 1200 rpm. As degree of actuation FW increases, lower rotational speed threshold n_max_lower increases until it reaches a lower limit rotational speed n1_lower at a limit degree of actuation FW1, for example, 3000 rpm. This increase in lower rotational speed threshold n_max_lower with increasing degree of actuation FW may, for example, be linear. If degree of actuation FW assumes a value above limit degree of actuation FW1, lower rotational speed threshold n_max_lower remains equal to lower limit rotational speed n1_lower. Lower rotational speed threshold n_max_lower is, for example, selected in such a way that it is higher than setpoint rotational speed n_setpoint. For example, setpoint rotational speed n_setpoint may be 1800 rpm and lower rotational speed threshold n_max_lower may be 2000 rpm.

Upper rotational speed threshold n_max_upper may be selected completely analogously to lower rotational speed threshold n_max_lower, so that upper rotational speed threshold n_max_upper is above lower rotational speed threshold n_max_lower for all degrees of actuation FW. In the exemplary embodiment, the profile of upper rotational speed threshold n_max_upper over degree of actuation FW is not characterized by lower initial value n0_lower and lower limit rotational speed n1_lower as in the case of lower rotational speed threshold n_max_lower, but rather in a similar manner by an upper initial value n0_upper and an upper limit rotational speed n1_upper.

As further depicted in FIG. 1, the rotational speed monitoring in the second level receives request SE for injecting fuel and control command IE from the first level. This makes it possible for the rotational speed monitoring to monitor injections of fuel into internal combustion engine 10. However, it is also possible that control command IE is not transmitted to the rotational speed monitoring, but that the rotational speed monitoring reads out a counter in injector control 30 which monitors how often injections in internal combustion engine 10 have been requested via control command IE.

The rotational speed monitoring furthermore receives the actual rotational speed n of internal combustion engine 10, which is ascertained in a known manner.

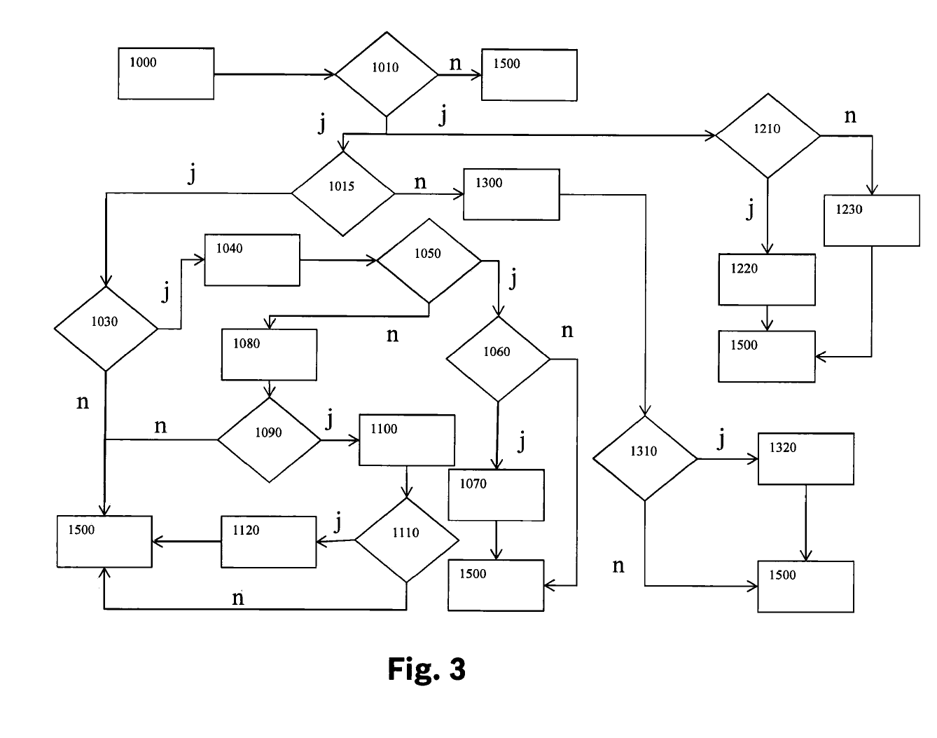

FIG. 3 shows the sequence of the method in the rotational speed monitoring. The method begins at step 1000 and is, for example, periodically repeated cycle-synchronously with the cycles of internal combustion engine 10. In step 1010, it is checked whether actual rotational speed n is greater than lower rotational speed threshold n_max_lower. If this is not the case, the rotational speed monitoring ends at step 1500.

However, if the query shows that actual rotational speed n exceeds lower rotational speed threshold n_max_lower, the method branches to step 1015, in which the additional control of internal combustion engine 10 is determined Alternatively or additionally, the method branches to step 1210, in which the additional control of electric machine 40 is determined

In step 1015, it is checked whether actual rotational speed n exceeds upper rotational speed threshold n_max_upper. If this is the case, step 1030 follows. If this is not the case, step 1300 follows.

In step 1030, it is checked whether requests SE for injecting fuel are transmitted to injector control 30 in the first level. If this is not the case, it is determined that the first level has initiated sufficient actions for reducing actual rotational speed n, and the method ends at step 1500. However, if it is determined that despite the presence of increased actual rotational speed n, requests SE for injecting fuel to injector control 30 are transmitted, step 1040 follows. In step 1040, the second level transmits command CMD to injector control 30 that no control command IE is to be transmitted to the injectors, i.e., that no fuel is to be injected, even if requests SE are present for injecting fuel.

Step 1050 follows, in which it is ascertained whether no control commands IE are now transmitted to the injectors, i.e., whether no fuel is actually injected into internal combustion engine 10 after transmitting command CMD. The functional implementation of command CMD is potentially subject to a time delay, since previously requested injections are possibly still being implemented.

For this reason, it is advantageously possible to observe the implementation of command CMD at least over the maximum period required for the functional implementation via the injection before further actions are initiated.

If a correct implementation of command CMD has been carried out, i.e., if no fuel is actually injected, step 1060 follows, in which it is checked whether actual rotational speed n carries out critical oscillations as a result of the conditional deactivation of the injection. For example, it is determined that critical oscillations are present if actual rotational speed n oscillates about upper rotational speed threshold n_max_upper, and if actual rotational speed n accelerates too rapidly in the acceleration phases of the oscillation, i.e., if the maximum value of the gradient of actual rotational speed n exceeds the predefinable threshold value.

If it is determined that no critical oscillations are present, the method ends at step 1500. On the other hand, if it is determined that critical oscillations are present, step 1070 follows, in which counteractions are taken. For example, a switchover is made to emergency air operation, i.e., the throttle valve is de-energized, so that only a significantly reduced quantity of air is able to flow into the internal combustion engine via a residual gap. Alternatively or in addition, it may be provided that upper rotational speed threshold n_max_upper is reduced, for example, by the characteristic curve of upper rotational speed threshold n_max_upper over degree of actuation FW depicted in FIG. 2 being replaced by an emergency characteristic curve, in which upper rotational speed threshold n_max_upper assumes lower values. The method subsequently ends at step 1500.

If it is determined in step 1050 that the injection of fuel has not been effectively prevented, counteractions are initiated in order to effectively prevent fuel from being injected.

Step 1080 initially follows, in which a software reset of control unit 1 is optionally carried out.

Step 1090 then follows, in which, after the predefinable time interval has elapsed, it is checked whether the fault is still present, i.e., whether fuel is still being injected into internal combustion engine 10 via control command IE despite transmitting command CMD. If this is not the case, it is determined that the actions taken are working, and the method ends at step 1500. If this is not the case, step 1100 follows. In step 1100, if no fault is present in electric machine 40, a hardware injection suppression is optionally carried out, i.e., a reset of the mechanism is carried out in the injector control with which control command IE may be suppressed via command CMD. The hardware communication interfaces of control unit 1, for example, a CAN bus, remain unaffected. Step 1110 follows.

In step 1110, similarly to step 1090, it is checked whether the fault is still present after the second predefinable time interval has elapsed. If this is not the case, step 1500 follows, in which the method ends. However, if injections are still present, step 1120 follows. Here, the watchdog of the third level carries out a deactivation. Injector control 30 and the hardware communication interfaces of control unit 1, for example, the CAN bus, are deactivated. This results in other components of the drive receiving no more commands from control unit 1 and going into safe emergency operation. Step 1500 follows, at which the method ends.

In step 1300, the second level transmits a setpoint rotational speed n_setpoint to the first level, which increases slowly, i.e., the time gradient of setpoint rotational speed n_setpoint is limited to a maximum value, for example, via corresponding filtering. If no fault is now present, an increased driver input which corresponds to the increased degree of actuation FW is implemented in a somewhat delayed manner, but is possible. Step 1310 follows, in which it is checked whether the time gradient of actual rotational speed n exceeds the predefinable second threshold value. If this is not the case, it is determined that no fault is present, and the method ends at 1500. However, if the time gradient of actual rotational speed n exceeds the second predefinable threshold value, step 1320 follows. In step 1320, one or multiple actions is/are initiated for reducing the torque generated by internal combustion engine 10; for example, the emergency air mode is initiated. The method subsequently ends at step 1500.

During the response of the electric machine, it is initially checked in step 1210 whether a braking intervention is present, i.e., whether (as described above in a broad sense) a braking request by the driver is present. If this is the case, step 1220 follows. In step 1220, actions are taken in order to support the braking request using the electric machine. For example, electric machine 40 may be controlled in such a way that it may be operated only as a generator. However, it is alternatively or additionally possible that an electric setpoint braking torque is predefined for electric machine 40 by the second level, which electric machine 40 attempts to set. The method subsequently ends at step 1500.

On the other hand, if it is determined that the braking request is not present, step 1230 follows, in which electric machine 40 is controlled in such a way that it may be operated only as a generator, i.e., in particular, that electric machine 40 is not able to be operated as a motor.

It is to be understood for those skilled in the art that all components and signals described here may be implemented in software; or they may also be implemented completely as hardware, or they may also be implemented partially as hardware and partially as software.

What is claimed is:

1. A method for a safe operation of a drive of a motor vehicle, comprising:
rotational speed monitoring in which, if an actual rotational speed of an internal combustion engine exceeds a predefinable lower rotational speed threshold, a fault response action is carried out, the fault response action being selected as a function of whether an additional predefinable condition is present.

2. The method as recited in claim 1, wherein the additional predefinable condition includes whether the actual rotational speed also exceeds a predefinable upper rotational speed threshold.

3. The method as recited in claim 2, wherein, if the actual rotational speed exceeds the predefinable upper rotational speed threshold, further comprising checking whether a request for injecting fuel is transmitted to an injector control of a control unit, whereupon, if the request for injecting fuel is transmitted, a command is transmitted to the injector control, to not transmit the control command for injecting fuel to an injector, despite the request.

4. The method as recited in claim 3, wherein, if the command results in the injector control not transmitting the control command to the injector for injecting fuel, and at least one of (1) if the actual rotational speed of the internal combustion engine oscillates about the predefinable upper rotational speed threshold, and (2) if a maximum value of a gradient of the actual rotational speed exceeds a predefinable threshold value during a period of this oscillation, at least one action of a plurality of actions is initiated for reducing a torque generated by the internal combustion engine.

5. The method as recited in claim 4, wherein the plurality of actions includes an initiation of an emergency air mode.

6. The method as recited in claim 4, wherein the plurality of actions includes reducing a predefinable upper rotational speed threshold.

7. The method as recited in claim 4, wherein, if the control command for injecting fuel is transmitted to the injector despite the command, a reset of control software of the control unit is carried out.

8. The method as recited in claim 4, wherein, if fuel is still being injected after a predefinable time interval has elapsed, despite the transmission of the command, and if no fault is present in an electric machine of the drive, a deactivation of the injection system of the internal combustion engine is carried out.

9. The method as recited in claim 4, wherein, if fuel is still being injected after a second predefinable time interval has elapsed, despite the transmission of the command, a deactivation of the injection system of the internal combustion engine and a deactivation of a communication interface of the control unit are carried out.

10. The method as recited in claim 2, wherein, if the actual rotational speed does not exceed the predefinable upper rotational speed threshold, a setpoint rotational speed is predefined, the setpoint rotational speed corresponding to a setpoint value specification for a control of the actual rotational speed.

11. The method as recited in claim 10, wherein another fault response action is initiated as a function of whether a time gradient of the actual rotational speed exceeds a second gradient threshold value.

12. The method as recited in claim 11, wherein, if the time gradient of the actual rotational speed exceeds the second gradient threshold value, at least one action of a plurality of actions is initiated for reducing a torque generated by the internal combustion engine.

13. The method as recited in claim 1, wherein the additional predefinable condition includes whether an intervention of a braking system is present, an additional drive unit of the drive being controlled as a function of whether an intervention of a braking system is present.

14. The method as recited in claim 13, wherein the additional drive unit includes an electric machine.

15. The method as recited in claim 13, wherein, if the intervention of the braking system is present, the additional drive unit is operated only as a generator.

16. The method as recited in claim 15, wherein a generator setpoint torque is predefined for the additional drive unit.

17. The method as recited in claim 13, wherein, if no intervention is present, the additional drive unit is operated only as a generator.

18. A computer program to carry out a method for a safe operation of a drive of a motor vehicle, comprising:
rotational speed monitoring in which, if an actual rotational speed of an internal combustion engine exceeds a predefinable lower rotational speed threshold, a fault response action is carried out, the fault response action being selected as a function of whether an additional predefinable condition is present.

19. An electronic storage medium storing a computer program to carry out a method for a safe operation of a drive of a motor vehicle, comprising:
rotational speed monitoring in which, if an actual rotational speed of an internal combustion engine exceeds a predefinable lower rotational speed threshold, a fault response action is carried out, the fault response action being selected as a function of whether an additional predefinable condition is present.

20. A control unit, comprising:
an electronic storage medium storing a computer program to carry out a method for a safe operation of a drive of a motor vehicle, comprising:
rotational speed monitoring in which, if an actual rotational speed of an internal combustion engine exceeds a predefinable lower rotational speed threshold, a fault response action is carried out, the fault response action being selected as a function of whether an additional predefinable condition is present.
